(19) United States
(12) Patent Application Publication
(10) Pub. No.: US 2026/0266427 A1
(43) Pub. Date: Sep. 10, 2026

(54) COMPOSITE MATERIAL HIGH-PRESSURE VESSEL WITH ENHANCED SEALING BETWEEN METAL NOZZLE BOSS AND PLASTIC LINER JOINT

(71) Applicants: KIMTEC CO., LTD., Miryang-si (KR); DONGSEO DNC CO., LTD., Miryang-si (KR)

(72) Inventors: Jong Sik KIM, Miryang-si (KR); Eung Yong KIM, Busan (KR)

(73) Assignees: KIMTEC CO., LTD., Miryang-si (KR); DONGSEO DNC CO., LTD., Miryang-si (KR)

(21) Appl. No.: 19/632,304

(22) Filed: Mar. 29, 2026

Related U.S. Application Data
(63) Continuation of application No. PCT/KR2025/007697, filed on Jun. 5, 2025.

(30) Foreign Application Priority Data
Mar. 4, 2025 (KR) 10-2025-0027355

(51) Int. Cl. F17C 1/16

(52) U.S. Cl. CPC F17C 1/16; F17C 2201/0109; F17C 2203/0604; F17C 2205/0305; F17C 2221/012; F17C 2223/0123; F17C 2260/036

(57) ABSTRACT

According to the present invention, there is provided a composite material high-pressure vessel including: a metal nozzle boss combined with a plastic liner, a plastic liner including a plastic liner protrusion into and with which the metal nozzle boss is inserted, a bushing arranged in such a way that a part of the bushing is inserted into the through hole of the plastic liner protrusion and the other part of the bushing is fitted between the metal nozzle boss and the plastic liner protrusion, and O-rings, which, in order to maintain sealing between the plastic liner protrusion and the bushing, are fitted into an outer circumferential surface of the bushing and arranged in such a way that a plurality of O-rings are spaced apart from each other in the lengthwise direction between an inner circumferential surface of the plastic liner protrusion and the bushing.

### CROSS-REFERENCE TO RELATED APPLICATION

This application is a continuation application of PCT International Patent Application No. PCT/KR2025/007697 filed on Jun. 5, 2025, which claims priority to Korean Patent Application No. 10-2025-0027355 filed on Mar. 4, 2025, which are all hereby incorporated by reference in their entirety.

### BACKGROUND

The present invention relates to a composite material high-pressure vessel with enhanced sealing between a metal nozzle boss and a plastic liner joint, and more particularly, to a composite material high-pressure vessel with enhanced sealing between a metal nozzle boss and a plastic liner joint in which a sealing member for enhancing sealing is fitted between an inner circumferential surface of a plastic liner protrusion and a bushing inserted into the plastic liner protrusion.

High-pressure vessels, such as fuel storage tanks for natural gas vehicles or hydrogen storage tanks for fuel cell vehicles, are manufactured by making a liner using a thermoplastic resin, such as high-density polyethylene (HDPE) or nylon for lightweight, and winding carbon fibers or glass fibers impregnated with a thermosetting resin, such as an epoxy resin, on the liner. In this case, metal nozzle bosses are inserted at ends of a plastic liner for connection to regulators or valves. According to the related art, liners are made of metal and then wrapped with carbon fibers or glass fibers impregnated with a thermosetting polymer resin. However, recently, for lightweight and reducing gas refueling times, plastic liners are manufactured by injection molding, roto-molding or blower molding using thermoplastic resins such as HDPE or nylon, and carbon fibers or glass fibers impregnated with a thermosetting resin, such as an epoxy resin or a polyester resin, are wound on the plastic liners. Composite material vessels using metal liners are heavy, highly susceptible to corrosion, and have high manufacturing costs. On the other hand, composite material vessels using plastic liners are lightweight, corrosion-resistant, resistant to repeated filling fatigue, and offer short gas filling times. For these reasons, the development of various composite material vessels using plastic liners has been actively carried out.

However, when using plastic liners, the plastic liner and the metal nozzle boss are not completely in close contact with each other during environmental testing at extreme temperatures and repeated pressurization, which are test conditions for pressure vessels, so that sealing cannot be achieved. Thus, the development of a method which is simple and can enhance sealing between the plastic liner and the nozzle boss, is necessary.

### SUMMARY

The present invention provides a composite material high-pressure vessel with enhanced sealing between a metal nozzle boss and a plastic liner joint in which a sealing member for enhancing sealing is fitted between an inner circumferential surface of a plastic liner protrusion and a bushing inserted into the plastic liner protrusion.

[6] According to an aspect of the present invention, there is provided a composite material high-pressure vessel including a combination of a metal nozzle boss and a plastic liner joint, the composite material high-pressure vessel including: a metal nozzle boss, which has a hollow cavity formed therein in a lengthwise direction in which a nozzle is inserted, has both ends open in the lengthwise direction and is combined with the plastic liner; a plastic liner including a plastic liner protrusion, wherein the plastic liner protrusion protrudes from at least one end of both ends in a lengthwise direction of the plastic liner, has a through hole formed therein and in which the metal nozzle boss is inserted into and combined with an outside of the through hole; a bushing arranged in such a way that a part of the bushing is inserted into the through hole of the plastic liner protrusion and the other part of the bushing is fitted between the metal nozzle boss and the plastic liner protrusion; and O-rings, which, in order to maintain sealing between the plastic liner protrusion and the bushing, are fitted into an outer circumferential surface of the bushing and arranged in such a way that a plurality of O-rings are spaced apart from each other in the lengthwise direction between an inner circumferential surface of the plastic liner protrusion and the bushing, wherein the bushing includes: a bushing body portion having both ends open, having a hollow cavity formed therein, and having an outer circumferential surface arranged to face the inner circumferential surface of the plastic liner protrusion; and a bushing flange portion, which is integrally connected to an end of the bushing body portion arranged closer to a portion of the metal nozzle boss into which the nozzle is inserted, among both ends of the bushing body portion, extends in a direction away from a center of the bushing body portion and arranged to be fitted between the plastic liner protrusion and the metal nozzle boss.

A composite material high-pressure vessel with enhanced sealing between a metal nozzle boss and a plastic liner joint according to the present invention has the following effects.

First, a sealing member is fitted between an inner circumferential surface of a plastic liner protrusion and a bushing inserted into the plastic liner protrusion so that sealing can be enhanced.

Second, since the sealing member is only fitted into an outer circumferential surface of the bushing, even workers without professional skills can easily install the sealing member.

Third, since the bushing is inserted between a plastic liner protrusion and a nozzle boss, the depression of the plastic liner protrusion with weakened rigidity due to the formation of screw threads can be prevented.

### BRIEF DESCRRIPTION OF THE DRAWINGS

FIG. 1 is a schematic diagram illustrating a composite material high-pressure vessel with enhanced sealing of a metal nozzle boss and a plastic liner joint according to an embodiment of the present invention;

FIG. 2 is an exploded perspective view of the composite material high-pressure vessel with enhanced sealing between the metal nozzle boss and the plastic liner joint shown in FIG. 1;

FIG. 3 is an enlarged schematic diagram illustrating the combined structure of a sealing member in the composite material high-pressure vessel with enhanced sealing between the metal nozzle boss and the plastic liner joint shown in FIG. 1;

FIG. 4 is a schematic diagram illustrating a case where a nozzle N is combined with the composite material high-pressure vessel with enhanced sealing between the metal nozzle boss and the plastic liner joint shown in FIG. 1; and

FIG. 5 is a schematic diagram illustrating a composite material high-pressure vessel with enhanced sealing between a metal nozzle boss and a plastic liner joint according to another embodiment of the present invention.

### DETAILED DESCRITION

Hereinafter, the present invention will be described in detail by explaining embodiments of the present invention with reference to the accompanying drawings.

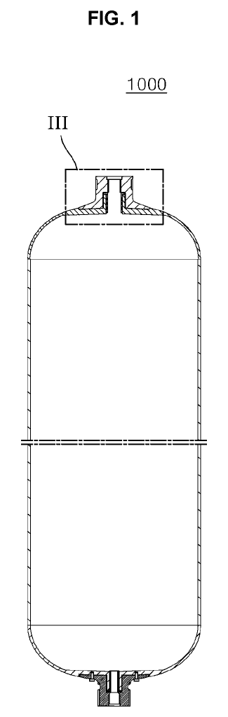

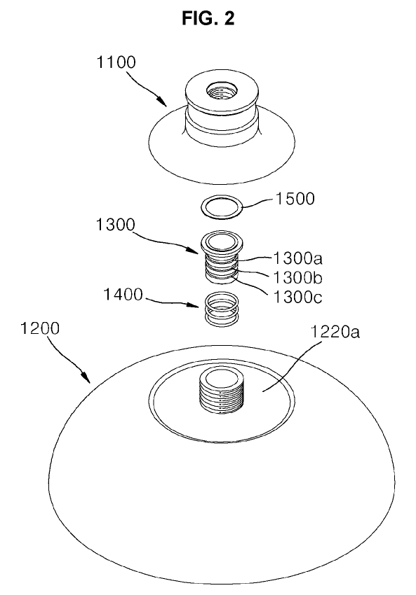

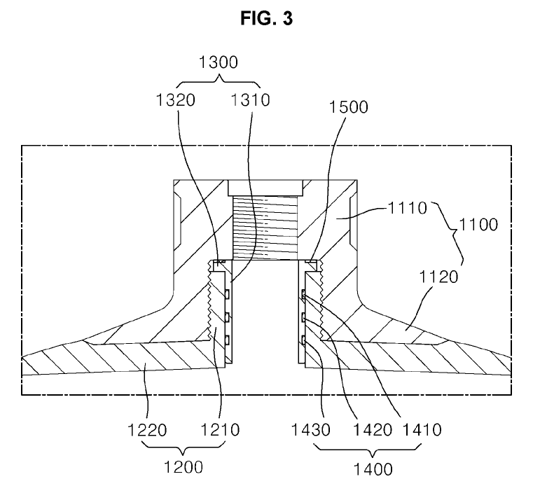

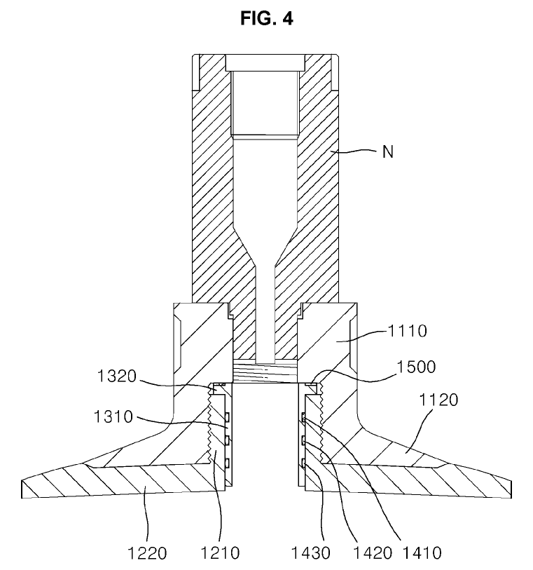

Referring to FIGS. 1 through 4, a composite material high-pressure vessel 1000 according to an embodiment of the present invention has the advantage of excellent sealing between a metal nozzle boss and a plastic liner joint. The composite material high-pressure vessel 1000 may be used to store hydrogen or compressed natural gas in a high-pressure state. The composite material high-pressure vessel 1000 includes a metal nozzle boss 1100, a plastic liner 1200, a bushing 1300, an O-ring 1400, and a washer 1500.

The metal nozzle boss 1100 has a hollow cavity formed therein in a lengthwise direction in which a nozzle N is inserted, has both ends in the lengthwise direction open, and is combined with the plastic liner 1200. Specifically, the metal nozzle boss 1100 includes a nozzle boss center 1110 and a nozzle boss wing portion 1120, which are integrally connected to each other.

The nozzle boss center 1110 has a hollow cavity formed therein in a direction in which the nozzle N is inserted (hereinafter, referred to as a ‘first hollow cavity’). The nozzle boss center 1110 has both ends open in the lengthwise direction. That is, the nozzle boss center 1110 has generally a structure similar to a cylindrical tube.

And, screw threads are formed on the inner circumferential surface of the nozzle boss center 1110. This is for the purpose of screw coupling with a plastic liner protrusion 1210 to be described below. The nozzle boss center 1110 also has screw threads formed on an outer circumferential surface of the nozzle boss center 1110.

In the present embodiment, a portion of the nozzle boss center 1110 including an end into which the nozzle N is inserted, among both ends of the nozzle boss center 1110 is referred to as an upper part of the metal nozzle boss 1100, and a portion including the other end that is an opposite end is referred to as a lower part of the metal nozzle boss 1100. A lower end of the upper part of the metal nozzle boss 1100 and an upper end of the lower part of the metal nozzle boss 1100 are integrally connected to form a communication structure. And, hereinafter, a portion closer to one end of the metal nozzle boss 1100 into which the nozzle N is inserted, is referred to as an upper part of the plastic liner 1200 and the bushing 1300, respectively, and a portion farther away from one end of the metal nozzle boss 1100 is referred to as a lower part of the plastic liner 1200 and the bushing 1400, respectively.

The hollow cavity formed in the center of the nozzle boss center 1110 has a stepped structure that extends uniformly from the top to the bottom and becomes wider in diameter. The upper part of the nozzle boss center 1110 forms a part with a smaller diameter among the hollow cavity formed in the nozzle boss center 1110. And, the lower part of the nozzle boss center 1110 forms a part with a larger diameter among the hollow cavity formed in the nozzle boss center 1110. That is, the metal nozzle boss 1100 has a structure in which an inner diameter of the lower part of the nozzle boss center 1110 is greater than an inner diameter of the upper part of the nozzle boss center 1110.

In this case, a lower end of the upper part of the nozzle boss center 1110 is seated on the bushing 1300 inserted into the plastic liner 1200. And, the lower end of the lower part of the nozzle boss center 1110 is seated on the plastic liner body portion 1220 to be described below.

The nozzle boss wing portion 1120 is integrally connected to a lower part of the outer circumferential surface of the nozzle boss center 1110 combined with the plastic liner 1200. A lower surface of the nozzle boss wing portion 1120 is seated on the plastic liner body portion 1220 to be described below. That is, the metal nozzle boss 1100 has a structure in which each of the lower end of the nozzle boss center 1110 and the lower surface of the nozzle boss wing portion 1120 is seated on the plastic liner body portion 1220.

The nozzle boss wing portion 1120 extends in a direction away from the nozzle boss center 1110. The nozzle boss wing portion 1120 has a circular plate shape. However, the present invention is not limited thereto, and the shape of the nozzle boss wing portion 1120 may be changed.

The plastic liner 1200 includes the plastic liner protrusion 1210 and the plastic liner body portion 1220, which are integrally connected to each other. The plastic liner protrusion 1210 protrudes from at least one end of both ends in the lengthwise direction of the plastic liner 1200. In the present embodiment, the plastic liner protrusion 1210 is formed at both ends in the lengthwise direction of the plastic liner 1200. However, the present invention is not limited thereto, and the plastic liner protrusion 1210 may be formed only at one end of both ends in the lengthwise direction of the plastic liner 1200.

And, the plastic liner protrusion 1210 has a through hole formed therein. That is, the plastic liner protrusion 1210 has a structure similar to a cylindrical tube overall.

And, the plastic liner protrusion 1210 has a structure in which the metal nozzle boss 1100 is inserted into and combined with an outside of the through hole formed in the plastic liner protrusion 1210. Specifically, screw threads formed on the inner circumferential surface of the nozzle boss center 1110 and screw threads formed on the outer circumferential surface of the plastic liner protrusion 1210 are complementarily combined with each other, thereby screw-coupling the plastic liner protrusion 1210 and the nozzle boss center 1110.

The plastic liner body portion 1220 extends in a direction away from the plastic liner protrusion 1210 so that the nozzle boss center 1110 and the nozzle boss wing portion 1120 may be seated on the outside (upper) of the plastic liner body portion 1220. And, the plastic liner body portion 1220 has a groove 1220a so that the nozzle boss wing portion 1120 may be seated on the extended portion of the plastic liner body portion 1220.

The depth of the extended end of the groove 1220a is formed to be same as the thickness of the extended end of the nozzle boss wing portion 1120. That is, in a state in which the nozzle boss wing portion 1120 is seated on the groove 1220a, the upper surface of the plastic liner body portion 1220 that contacts the extended end of the groove 1220a forms a smooth surface without a step with the extended end of the nozzle boss wing portion 1120. Thus, the outer circumferential surface of the plastic liner body portion 1220 and the outer circumferential surface of the nozzle boss wing portion 1120 form a structure like an outer circumferential surface of one object.

The bushing 1300 is installed to prevent the depression (breakage) of the screw thread portion of the plastic liner protrusion 1210 when the metal nozzle boss 1100 and the plastic liner protrusion 1210 are combined with each other. The bushing 1300 is arranged in such a way that a part of the bushing 1300 is inserted into the through hole of the plastic liner protrusion 1210 and the other part of the bushing 1300 is fitted between the metal nozzle boss 1100 and the plastic liner protrusion 1210. Specifically, the bushing 1300 includes a bushing body portion 1310 and a bushing flange portion 1320, which are integrally connected to each other.

The bushing body portion 1310 has a cylindrical tube structure in which both ends of the bushing body portion 1310 are open and a hollow cavity is formed. And, the bushing body portion 1310 is inserted (fitted) and arranged so that the outer circumferential surface of the bushing body portion 1310 is in close contact with and faces the inner circumferential surface of an inner diameter of the plastic liner protrusion 1210.

And, a plurality of bushing grooves are formed in the outer circumferential surface of the bushing body portion 1310 so that an O-ring 1400 may be stably fixed in a fitted state. In the present embodiment, a first bushing groove 1300a, a second bushing groove 1300b, and a third bushing groove 1300c are formed in the bushing body portion 1310. The first bushing groove 1300a, the second bushing groove 1300b, and the third bushing groove 1300c are spaced apart from each other in the lengthwise direction (vertical direction) of the bushing body portion 1310. In the present embodiment, a separation distance between the first bushing groove 1300a and the second bushing groove 1300b and a separation distance between the second bushing groove 1300b and the third bushing groove 1300c are formed to be same. However, the present invention is not limited thereto, and the number of the bushing grooves and a formation distance of the bushing grooves may be changed.

The bushing flange portion 1320 has a circular ring structure with a through hole formed in the center of the bushing flange portion 1320. The bushing flange portion 1320 is integrally connected to the end of the bushing body portion 1310 that is arranged closer to the part (one end) of the metal nozzle boss 1100 into which the nozzle N is inserted, among both ends of the bushing body portion 1310.

And, the bushing flange portion 1320 extends in a direction away from the center of the bushing body portion 1310. In this case, the bushing flange portion 1320 is seated on the upper end of the plastic liner protrusion 1210 and is in close contact with the upper end of the plastic liner protrusion 1210.

That is, the bushing flange portion 1320 has a structure, when the inner diameter of the bushing flange portion 1320 is the same as the inner diameter of the bushing body portion 1310, the lower part of the bushing flange portion 1320 is seated on the upper end of the bushing body portion 1310 and is integrally connected thereto and when the inner diameter of the bushing flange portion 1320 is greater than the inner diameter of the bushing body portion 1310, the outer circumferential surface of the bushing flange portion 1320 faces the upper outer circumferential surface of the bushing body portion 1310 and is integrally connected to each other.

And, when the inner diameter of the bushing flange portion 1320 is the same as the inner diameter of the bushing body portion 1310, a step structure is formed on the upper end of the bushing flange portion 1320. That is, when the inner diameter of the bushing flange portion 1320 is the same as the inner diameter of the bushing body portion 1310, a structure in which a portion connected to the bushing body portion 1310 (hereinafter, referred to as a ‘first portion’) among the bushing flange portion 1320 protrudes upwards more than a portion of the bushing flange portion 1320 that is seated on the upper end of the plastic liner protrusion 1210 (hereinafter, referred to as a ‘second portion’) among the bushing flange portion 1320, is formed. In this case, a washer 1500 to be described below is configured in such a way that a lower surface of the washer 1500 is seated on the second portion and an inner circumferential surface of the washer 1500 is in close contact with the outer circumferential surface of the first portion. In this case, the thickness of the washer 1500 is greater than a length at which the washer 1500 protrudes from an upper part of the first portion, so that the first portion and a lower end of the upper part of the metal nozzle boss 1100 are arranged to be spaced apart from each other.

And, when the inner diameter of the bushing flange portion 1320 is greater than the inner diameter of the bushing body portion 310, a stepped structure is not formed in the bushing flange portion 1320, and a stepped structure is formed between the bushing flange portion 1320 and the bushing body portion 1310. In this case, the bushing flange portion 1320 is seated on the upper end of the plastic liner protrusion 1210, and the washer 1500 is seated on the bushing flange portion 1320. And, the upper end of the bushing body portion 1310 is arranged to be spaced apart from the lower end of the upper part of the metal nozzle boss 1100.

And, the bushing flange portion 1320 is arranged to be fitted between the plastic liner protrusion 1210 and the metal nozzle boss 1100. The arrangement of the bushing flange portion 1320 to be fitted between the plastic liner protrusion 210 and the metal nozzle boss 1100 means that the bushing flange portion 1320 is arranged in a structure in which the lower end of the upper part of the nozzle boss center 1110 is seated on the bushing flange portion 1320 and is in close contact therewith while the bushing flange portion 1320 is seated on the upper end of the plastic liner protrusion 1210. Of course, in the present embodiment, since the washer 1500 is arranged between the bushing flange portion 1320 and the lower end of the upper part of the nozzle boss center 1110, the bushing flange portion 1320 has a structure in which the lower surface of the washer 1500 is seated on the bushing flange portion 1320 and is in close contact therewith.

A case where the bushing 1300 is formed of a metal material, will be exemplified. However, the present invention is not limited thereto, and a material for the bushing 1300 may be changed into a hard plastic material.

The O-ring 1400 is installed to maintain sealing between the plastic liner protrusion 1210 and the bushing 1300. The O-ring 1400 is fitted into the outer circumferential surface of the bushing 1300 and is arranged between the inner circumferential surface of the plastic liner protrusion 1210 and the bushing 1300. The inside of the O-ring 1400 is in close contact with the outer circumferential surface of the bushing body portion 1310, and the outside of the O-ring 1400 is in close contact with the inner circumferential surface of the plastic liner protrusion 1210.

The O-ring 1400 is arranged on the outer circumferential surface of the bushing 1300 in such a way that a plurality of O-rings 1400 are spaced apart from each other in the lengthwise direction. Specifically, the plurality of O-rings 1400 are arranged on the outer circumferential surface of the bushing body portion 1310 to be spaced apart from each other in the lengthwise direction.

In the present embodiment, the O-ring 1400 includes a first O-ring 1410, a second O-ring 1420, and a third O-ring 1430. The first O-ring 1410 is fitted into the first bushing groove 1300a, the second O-ring 1420 is fitted into the second bushing groove 1300b, and the third O-ring 1430 is fitted into the third bushing groove 1300c. A separation distance between the first O-ring 1410 and the second O-ring 1420 and a separation distance between the second O-ring 1420 and the third O-ring 1430 are formed to be same. However, the present invention is not limited thereto, and the number of the O-rings 1400 and an arrangement distance of the O-rings 1400 may be changed.

In a state in which the first O-ring 1410, the second O-ring 1420 and the third O-ring 1430 are fitted into the first bushing groove 1300a, the second bushing groove 1300b, and the third bushing groove 1300c, respectively, a surface that is flat with the outer circumferential surface of the bushing body portion 1310, is formed. That is, the outer circumferential surface of each of the first O-ring 1410, the second O-ring 1420, and the third O-ring 1430 forms a flat surface with a portion where the first bushing groove 1300a, the second bushing groove 1300b and the third bushing groove 1300c are not formed, among the outer circumferential surfaces of the bushing body portion 1310 in the lengthwise direction (vertical direction) of the bushing body portion 1310.

The washer 1500 is arranged between the bushing 1300 and the metal nozzle boss 1100. Specifically, the washer 1500 is arranged to be seated on the bushing flange portion 1320. That is, the lower surface of the washer 1500 is arranged to be in close contact with the upper surface of the bushing flange portion 1320, and the upper surface of the washer 1500 is arranged to be in close contact with a lower end of the upper part of the nozzle boss center 1110. In this case, the washer 1500 has a circular ring structure. In the present embodiment, a case where the washer 1500 is included, will be exemplified, but the washer 1500 may not be included.

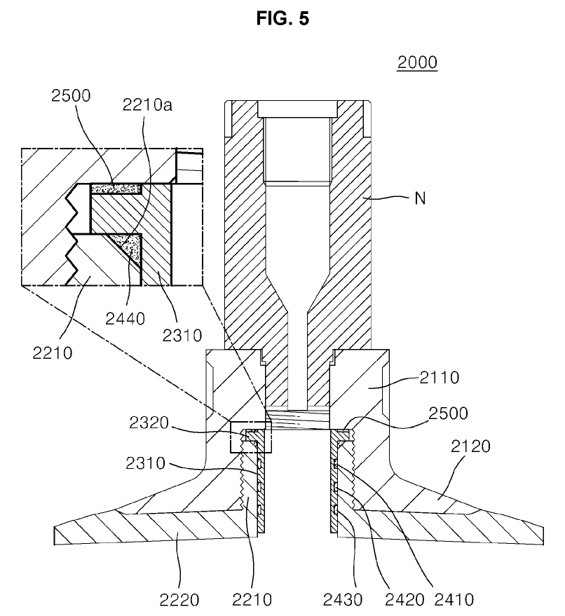

Referring to FIG. 5, a composite material high-pressure vessel 2000 according to another embodiment of the present invention includes a metal nozzle boss 2100, a plastic liner 2200, a bushing 2300, an O-ring 2400, and a washer 2500. The composite material high-pressure vessel 2000 according to the present embodiment is different from the composite material high-pressure vessel 1000 shown in FIGS. 1 through 4 in the plastic liner 2200 and the O-ring 2400, and the remaining components are similar. Thus, the description will focus on different parts, and the detailed description of components with similar configuration will be omitted.

The plastic liner 2200 includes a plastic liner protrusion 2210 and a plastic liner body portion 2220 that are integrally connected to each other. The plastic liner protrusion 2210 has a through hole formed therein. That is, the plastic liner protrusion 2210 has a structure similar to a cylindrical tube overall.

However, in the present embodiment, the plastic liner protrusion 2210 is different from the plastic liner protrusion 1210 of the composite material high-pressure vessel 1000 shown in FIGS. 1 through 4 in that a plastic liner inclination portion 2210a is formed on an upper part of the plastic liner protrusion 2210. That is, the plastic liner protrusion 2210 has the plastic liner inclination portion 2210a that is obliquely formed from an upper surface to an inner circumferential surface of the plastic liner protrusion 2210.

In the present embodiment, the plastic liner inclination portion 2210a is formed at a 45-degree angle. However, the present invention is not limited thereto, and the angle of the plastic liner inclination portion 2210a may be changed.

Specifically, the plastic liner inclination portion 2210a formed on an upper part of the plastic liner protrusion 2210 is formed with the same structure as an imaginary straight line connecting a portion set a predetermined distance toward the outer circumferential surface of the plastic liner protrusion 2210 at a portion where the upper surface and inner circumferential surface of the plastic liner protrusion 1210 are connected to each other (hereinafter, referred to as a ‘first portion’) and a portion set at a predetermined distance in the direction of the plastic liner body portion 2220 from the point where the upper surface and inner circumferential surface of the plastic liner protrusion 1210 are connected to each other, wherein the portion is between the O-rings 2400 positioned closest to the upper surface of the plastic liner protrusion 2210 among the O-rings 2400 arranged between the inner circumferential surface of the plastic liner protrusion 2210 and the bushing 2300 (hereinafter, referred to as a ‘second portion), in a straight line. That is, the plastic liner inclination portion 2210a formed on the upper part of the plastic liner protrusion 2210 has a structure similar to that obtained by removing a portion of the plastic liner protrusion 1210 including the portion where the upper surface and inner circumferential surface of the plastic liner protrusion 1210 are connected to each other, among two portions partitioned by the imaginary line connecting the first portion and the second portion among the plastic liner protrusions 1210 of the composite material high-pressure vessel 1000 shown in FIGS. 1 through 4.

The O-ring 2400 includes a first O-ring 2410 fitted into the first bushing groove 2300a, a second O-ring 2420 fitted into the second bushing groove 2300b, a third O-ring 2430 fitted into the third bushing groove 2300c, and an upper O-ring 2440. That is, the composite material high-pressure vessel 1000 shown in FIGS. 1 through 4 includes the first O-ring 1410, the second O-ring 1420, and the third O-ring 1430, but in the present embodiment, the O-ring 2400 further includes the upper O-ring 2440 arranged at an upper part of the first O-ring 1410.

The inner side of the upper O-ring 2440 is in close contact with the outer circumferential surface of the bushing body portion 2310, and the outer side of the upper O-ring 2440 is in close contact with the plastic liner inclination portion 2210a. In this case, a groove such as the first bushing groove 2300a, the second bushing groove 2300b, and the third bushing groove 2300c are not formed in the bushing body portion 2310 that the inner side of the upper O-ring 2440 closely contacts, and the bushing body portion 2310 has a flat structure.

The upper O-ring 2440 is further compressed along the plastic liner inclination portion 2210a whenever the internal pressure of the plastic liner 2200 is applied to the upper O-ring 2440. Thus, the upper O-ring 2440 is in close contact with the plastic liner protrusion 2210.

While the present invention has been particularly shown and described with reference to exemplary embodiments thereof, it will be understood by those of ordinary skill in the art that various changes in form and details may be made therein without departing from the spirit and scope of the present invention as defined by the following claims.

A composite material high-pressure vessel in which a sealing member is fitted between an inner circumferential surface of a plastic liner protrusion and a bushing inserted into the plastic liner protrusion so that sealing can be enhanced, may be provided.

What is claimed is:

1. A composite material high-pressure vessel including a combination of a metal nozzle boss and a plastic liner, the composite material high-pressure vessel comprising:
a metal nozzle boss, which has a hollow cavity formed therein in a lengthwise direction in which a nozzle is inserted, has both ends open in the lengthwise direction and is combined with the plastic liner;
a plastic liner comprising a plastic liner protrusion, wherein the plastic liner protrusion protrudes from at least one end of both ends in a lengthwise direction of the plastic liner, has a through hole formed therein and in which the metal nozzle boss is inserted into and combined with an outside of the through hole;
a bushing arranged in such a way that a part of the bushing is inserted into the through hole of the plastic liner protrusion and the other part of the bushing is fitted between the metal nozzle boss and the plastic liner protrusion; and
O-rings, which, in order to maintain sealing between the plastic liner protrusion and the bushing, are fitted into an outer circumferential surface of the bushing and arranged in such a way that a plurality of O-rings are spaced apart from each other in the lengthwise direction between an inner circumferential surface of the plastic liner protrusion and the bushing,
wherein the bushing comprises:
a bushing body portion having both ends open, having a hollow cavity formed therein, and having an outer circumferential surface arranged to face the inner circumferential surface of the plastic liner protrusion; and
a bushing flange portion, which is integrally connected to an end of the bushing body portion arranged closer to a portion of the metal nozzle boss into which the nozzle is inserted, among both ends of the bushing body portion, extends in a direction away from a center of the bushing body portion and arranged to be fitted between the plastic liner protrusion and the metal nozzle boss.

2. The composite material high-pressure vessel of claim 1, wherein the O-rings each having an inner side being in close contact with the outer circumferential surface of the bushing body portion and an outer side being in close contact with the inner circumferential surface of the plastic liner protrusion.

3. The composite material high-pressure vessel of claim 1, wherein screw threads are formed on an inner circumferential surface of the metal nozzle boss, and screw threads that are complementarily combined with the screw threads formed on the metal nozzle boss are formed on the outer circumferential surface of the plastic liner protrusion, thereby screw-coupling the metal nozzle boss and the plastic liner protrusion.

4. The composite material high-pressure vessel of claim 1, wherein the bushing is formed of metal or a hard plastic material.

5. The composite material high-pressure vessel of claim 1, wherein the plastic liner protrusion has a plastic liner inclination portion that is obliquely formed from an upper surface to an inner circumferential surface of the plastic liner protrusion, and the O-rings further comprise an upper O-ring having an inner side being in close contact with the outer circumferential surface of the bushing body portion and an outer side being compressed along the plastic liner inclination portion whenever internal pressure of the plastic liner is applied to the upper O-ring.

6. The composite material high-pressure vessel of claim 5, wherein the plastic liner inclination portion is formed with the same structure as an imaginary straight line connecting a portion set a predetermined distance toward the outer circumferential surface of the plastic liner protrusion at a portion where the upper surface and inner circumferential surface of the plastic liner protrusion are connected to each other and a portion set at a predetermined distance in the direction of the plastic liner body portion from the point where the upper surface and inner circumferential surface of the plastic liner protrusion are connected to each other, wherein the portion is between the O-rings positioned closest to the upper surface of the plastic liner protrusion among the O-rings arranged between the inner circumferential surface of the plastic liner protrusion and the bushing, in a straight line.
